(19) United States
(12) Patent Application Publication
(10) Pub. No.: US 2022/0196430 A1
(43) Pub. Date: Jun. 23, 2022

(54) IDENTIFYING CHOKE POINTS IN AN ENVIRONMENT

(71) Applicant: Waymo LLC, Mountain View, CA (US)

(72) Inventors: Eric Tetsuo Matsumoto, Bethesda, MD (US); Carlos Richard Rivera, Milpitas, CA (US); Joshua S. Herbach, Belmont, CA (US); Xiang Gao, Belmont, CA (US)

(21) Appl. No.: 17/127,879

(22) Filed: Dec. 18, 2020

(51) Int. Cl. G01C 21/36; G01C 21/00; G01C 21/34

(52) U.S. Cl. CPC G01C 21/3694; G08G 1/0969; G01C 21/3415; G01C 21/3815

(57) ABSTRACT

Methods, systems, and apparatus, including computer programs encoded on computer storage media, for identifying choke points in an environment. One of the methods includes obtaining road data representing a plurality of roads in an environment; identifying one or more blockage points in the environment; generating a graph representing the environment, wherein: the graph comprises a plurality of nodes and edges, each node of the graph represents a respective location in the environment, each edge between a first node and a second node represents a road that connects the location in the environment represented by the first node and the location in the environment represented by the second node, and blockage points are not represented by nodes in the graph; processing the graph to determine a minimum cut of the graph; and determining, using the minimum cut of the graph, one or more choke points in the environment.

### BACKGROUND

This specification relates to autonomous vehicles. Autonomous vehicles include self-driving cars, boats, and aircraft. Autonomous vehicles use a variety of on-board sensors and computer systems to detect nearby objects and use such detections to make control and navigation decisions.

### SUMMARY

This specification describes a system implemented as computer programs on one or more computers in one or more locations that identifies one or more choke points in an environment.

In this specification, a choke point is a location on a road in an environment that is likely to have a larger amount of traffic flowing through it in at least one direction than if the environment contained no blockage points. A choke point can limit the flow of traffic from a first location in the environment to a second location in the environment as a result of one or more blockage points in the environment.

For example, there can be a single choke point between a first location and a second location, such that vehicles must navigate the choke point in order to travel from the first location to the second location. As another example, there can be multiple different choke points between a first location and a second location, such that vehicles must navigate one or more of the multiple choke points in order to travel from the first location to the second location. In other words, it is possible that a particular choke point is not necessary for a vehicle to navigate from a first location to a second location; e.g., a vehicle may choose from a set of a few choke points to navigate from the first location to the second location.

As another example, there may be one or a few choke points between a first region in the environment and a second region in the environment. That is, for a vehicle to travel from a location in the first region to a location in the second region, then the vehicle must navigate through one or more of the choke points.

The system can identify choke points between respective locations in the environment by generating a graph representing the environment, and determining a minimum cut of the graph. Each node of the graph can represent a respective location in the environment. Each location represented by a node that is in the minimum cut (if the minimum cut identifies a set of nodes), or that is incident to the minimum cut (if the minimum cut identifies a set of edges), can be considered a choke point.

The system can identify one or more blockage points in the environment. In this specification, a blockage point is a location on a road in an environment through which vehicles cannot navigate or through which traffic has been limited. For example, a blockage point can be a point on a road that is closed to traffic because of construction on the road, a vehicular accident on the road, flooding of the road, etc. As another example, a blockage point can be a point on a road where one or more lanes, but not all lanes, of the road have been closed; while this blockage point is still navigable by vehicles, the restriction of traffic relative to the normal capacity of the road can cause traffic congestion.

The presence of blockage points in an environment can cause choke points elsewhere in the environment, or exacerbate existing choke points in the environment, by forcing vehicles to use the choke points to navigate through the environment instead of using the roads that are blocked, as identified by the blockage points.

The subject matter described in this specification can be implemented in particular embodiments so as to realize one or more of the following advantages.

Using techniques described in this specification, a system can efficiently and effectively identify choke points in an environment that represent locations in the environment that may restrict movement within the environment. A system that is configured to generate a planned route for a vehicle, e.g., an on-board system of the vehicle, can use this information to make informed decisions for efficiently navigating through the environment. For example, the system can select a route for the vehicle that avoids the identified choke points if possible. That is, because the choke points are likely to have congested traffic, the system can determine that a route that avoids the choke points is likely to arrive at the destination quicker than a route that includes the choke points. Instead or in addition, an on-board system can notify a user about the identified choke points, e.g., by displaying data identifying the choke points on a user display of the vehicle, and recommend that the user avoid the choke points.

Instead or in addition, a system can use the identified choke points to make civil planning decisions. For example, the system can determine a prioritization of clearing up blockage points in the environment according to the choke points. As a particular example, when deciding an ordering in which to clear up two different blockage points, the system can select the blockage point that will reduce the negative effect of one or more of the choke points, e.g., by providing another alternative to the choke points for vehicles to navigate, to be cleared up first.

Instead or in addition, a system can use the identified choke points to determine whether the presence of a user test driver is necessary when performing a test drive of an autonomous vehicle. Because of the increased traffic at and around a choke point, there may be a higher likelihood that an autonomous vehicle that is being tested will encounter an issue that requires user attention when navigating through the choke point. Therefore, the system can determine, for a given test route, whether the test route includes any choke points, and accordingly determine whether it is necessary that a test driver accompany the autonomous vehicle on the test route.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example choke point identification system.

FIG. 2A, FIG. 2B, and FIG. 2C are illustrations of example graphs representing an environment.

FIG. 3 is an illustration of an example map that includes blockage points and a choke point.

FIG. 4 is a flow diagram of an example process for identifying choke points in an environment.

Like reference numbers and designations in the various drawings indicate like elements.

### DETAILED DESCRIPTION

This specification describes a system that identifies choke points in an environment.

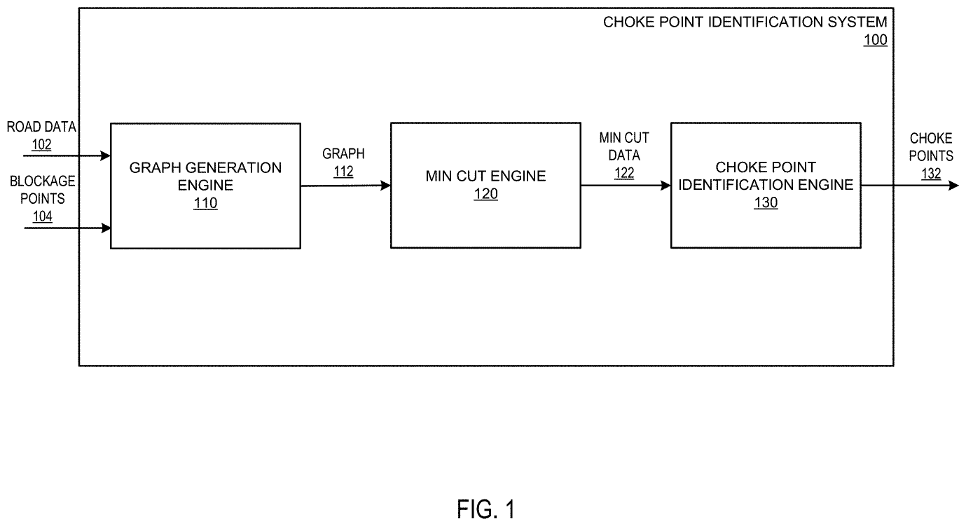

FIG. 1 is a diagram of an example choke point identification system 100. The choke point identification system 100 is an example of a system implemented as computer programs on one or more computers in one or more locations, in which the systems, components, and techniques described below can be implemented.

The choke point identification system 100 is configured to receive (i) road data 102 representing roads in an environment and (ii) data identifying one or more blockage points 104 in the environment, and to generate data identifying one or more choke points 132 in the environment.

The road data 102 can be any data that represents roads in the environment. For example, the road data 102 can include a map of the environment that includes each known road in the environment, and optionally other known features of the environment. As a particular example, the road data 102 can include a top-down image of the environment that depicts the features of the roads in the environment, such as the lanes of the road, cross walks, traffic lights, stop signs, and so on.

The blockage points 104 can include any location in the environment that is typically navigable by vehicles (e.g., a location that, according to the road data 102, is navigable) but that is not currently navigable, or whose navigability is currently restricted (e.g., because of lane closures). For example, a blockage point 104 can identify a location on a road that is closed, e.g., because the road is currently under construction, because there has been a traffic collision on the road, because the road has flooded or is otherwise unsafe, etc. As another example, a blockage point 104 can identify a location on a road for which data is unavailable, e.g., a location on a road that is not represented in the road data 102 or whose representation in the road data 102 is incomplete. As a particular example, a blockage point 104 can identify a location on a road whose representation in the road data 102 is outdated and needs to be updated; for example, the location on the road might have recently been under construction and thus have new features that are not represented by the road data 102. As another example, a blockage point 104 can identify a location on a road that is known to be difficult or dangerous to navigate. As a particular example, a blockage point 104 can identify a location on a road that typically becomes more dangerous to navigate in particular weather conditions, e.g., a road on a bridge that becomes icy before other roads. Such a blockage point 104 might be identified to the choke point identification system 100 when the environment is currently experiencing the particular weather conditions.

In some implementations, each blockage point 104 is represented by a polygon defined in a coordinate system of the road data 102, where the area in the environment represented by the polygon is blocked for traffic. The polygon representing a blockage point 104 can be any two-dimensional shape that identifies the area on the road that is blocked by the blockage point 104.

The choke point identification system 100 includes a graph generation engine 110, a min cut engine 120, and a choke point identification engine 130.

The graph generation engine 110 is configured to generate data representing a graph 112 that represents the environment. The graph 112 includes multiple nodes and edges. Each node represents a respective location in the environment, and each edge between a first node and a second node represents a road that connects the location in the environment represented by the first node and the location in the environment represented by the second node. A node is “incident to” an edge if the node is connected to a second node by the edge.

The graph 112 does not include nodes that represent the blockage points 104. That is, the graph 112 represents the locations in the environment that are currently navigable by vehicles. Because the locations represented by blockage points 104 are not currently navigable, they are not included in the graph 112.

For example, the graph generation engine 110 can generate a node for the graph 112 at regular intervals along each road in the environment. As a particular example, the graph generation engine 210 can generate a node for every n meters along each road. As another particular example, for each road represented by the road data 102, the graph generation engine 210 can generate a node for each n seconds that a vehicle travels down the road according to the speed limit of the road. That is, if the speed limit of the road is s miles per hour, then the generation engine 210 can generate a node for every

$$( s miles \text{/} hour \cdot 1 hour \text{/} 3600 seconds \cdot n seconds ) = \frac{n \cdot s}{3600} miles .$$

Instead or in addition to generating a node at regular intervals along each road in the environment, the graph generation engine 210 can generate a node for each intersection of two or more roads in the environment.

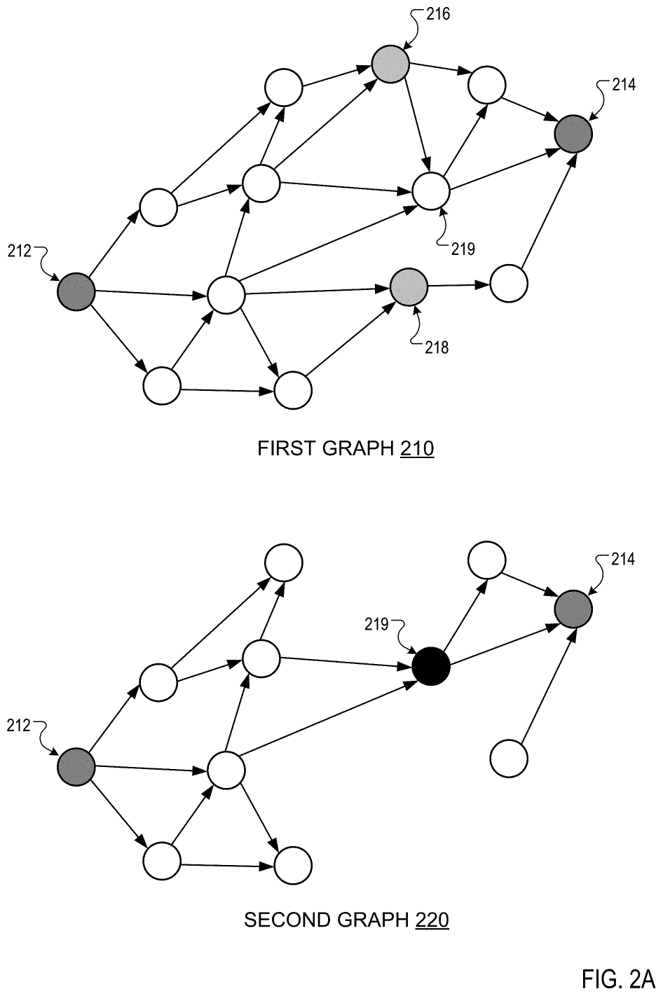

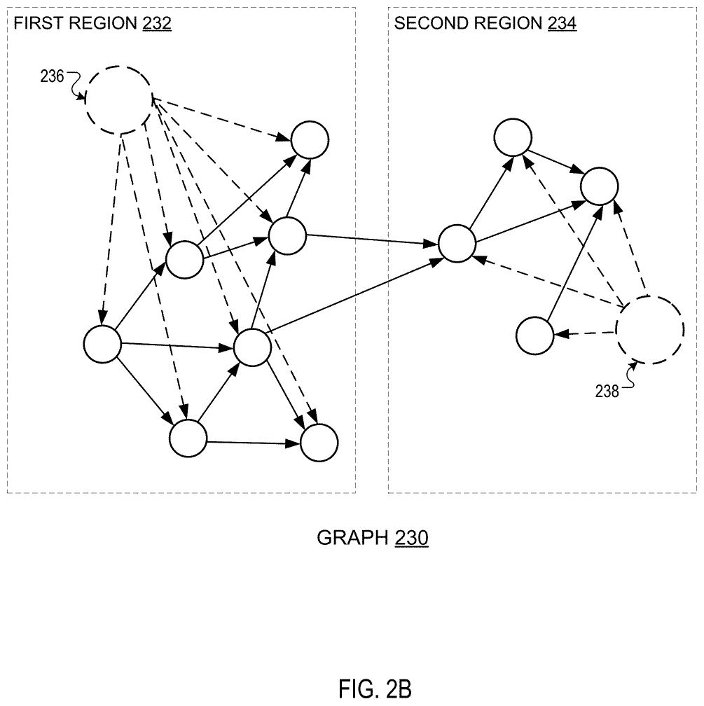

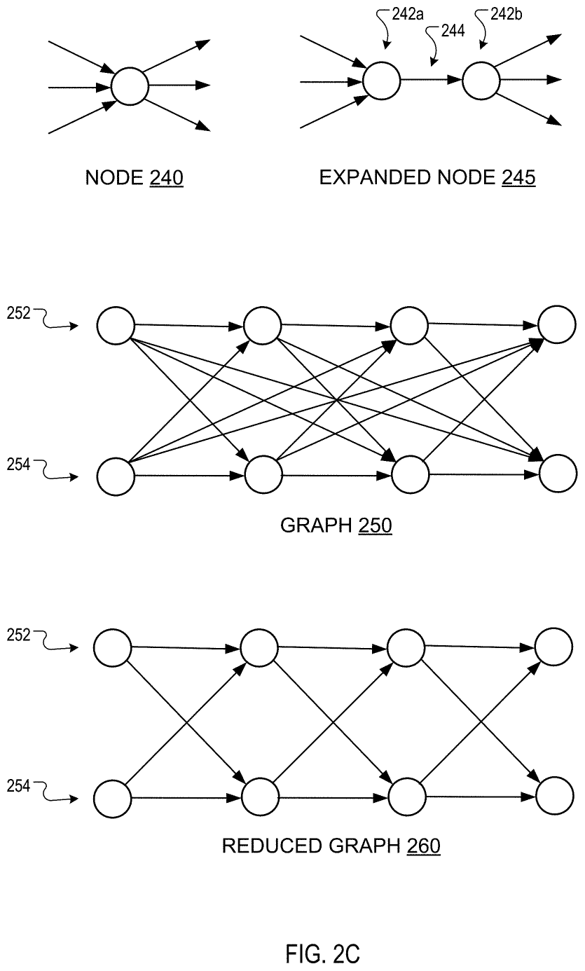

In some implementations, for each road in the environment, the graph 112 includes nodes for each lane of the road. An edge between two nodes representing respective lanes of the same road can represent possible lane changes of a vehicle. This is discussed in more detail below with respect to FIG. 2C.

Typically, the graph 112 is a directed graph. That is, each edge in the graph 112 is incident to a “source” node and a “destination” node and represents a flow of traffic from the location in the environment represented by the source node to the location in the environment represented by the destination node.

Typically, the graph 112 is unweighted or, alternatively, the weight of each edge in the graph is the same, e.g., 1.

In some implementations, the choke point identification system 100 receives an initial graph that includes nodes representing the blockage points 104. That is, the initial graph represents the environment if no blockage points were present. The graph generation engine 110 can then remove the nodes in the initial graph that represent blockage points 104 to generate the graph 112.

In some other implementations, the choke point identification system 100 does not include the graph generation engine 210, and instead receives the graph 112 as input.

The min cut engine 120 is configured to process the data representing the graph 112 and to generate min cut data 122 that represents one or more minimum cuts to the graph 112.

In this specification, a cut of a graph is a partition of the nodes of the graph into two disjoint subsets. A cut of a graph can identify (i) one or more edges of the graph that need to be removed from the graph in order to generate the two disjoint subsets of nodes or (ii) one or more nodes that need to be removed from the graph in order to generate the two disjoint subsets of nodes. A minimum cut of a graph is a cut of the graph generated such that some metric is minimized, e.g., the cumulative weight of one or more edges identified by the cut or the cumulative weight of one or more nodes identified by the cut. To generate a particular minimum cut of a graph, a system specifies one or more source nodes and one or more destination nodes, and the particular minimum cut identifies the minimum cut of the graph such that the first subset of the nodes includes at least the one or more source nodes and the second subset of the nodes includes at least the one or more destination nodes.

In some implementations, the minimum cut of the graph identifies one or more edges whose cumulative weights are the minimum among all possible cuts of the graph that partition the source nodes from the destination nodes. That is, removing the one or more identified edges generates two separate graphs, such that the destination nodes are not reachable from the source nodes and vice versa.

In some other implementations, the minimum cut of the graph identifies one or more nodes that are different from the source nodes and destination nodes and that represent the fewest number of nodes of all possible cuts of the graph that partition the source nodes from the destination nodes. That is, removing the one or more identified nodes (and any incident edges of the identified nodes) generates two separate graphs, such that the destination nodes are not reachable from the source nodes and vice versa.

The min cut engine 120 can generate multiple different minimum cuts of the graph 112 each corresponding to a different pair of locations in the environment or a different pair of sets of locations in the environment.

For example, the min cut engine 120 can divide the environment into multiple regions, and generate a respective minimum cut between each pair of regions of the environment. As a particular example, the min cut engine 120 can divide the environment into a two-dimensional grid.

For each determined region in the environment, the min cut engine 120 can select one or more locations in the region. In some implementations, the min cut engine can select the one or more locations in a region at random. In some other implementations, the min cut engine can select one or more locations of interest in the region, e.g., locations that represent important landmarks in the environment. For example, the min cut engine 120 can receive a user input annotating the important landmarks in the environment, and select the one or more locations in each region according to the user input.

For each pair of determined regions in the environment, the min cut engine 120 can generate a minimum cut between the respective selected locations in the pair of regions. That is, the min cut engine 120 can generate a minimum cut where the source nodes are the nodes in the graph 112 that represent the selected locations in the first region and the destination nodes are the nodes of the graph 112 that represent the selected locations in the second region. The min cut engine 120 can also generate a different minimum cut where the source nodes correspond to the second region and the destination nodes correspond to the first region. That is, the minimum cut of flow from a first region to a second region can be different from the minimum cut of flow from the second region to the first region. For example, the environment can include one-way roads along which vehicles can only travel in one direction.

In some other implementations, for each region of the environment, the min cut engine 120 can insert a virtual node into the graph 112, and a respective virtual edge between the virtual node and each node in the graph 112 representing a location in the region of the environment. For each pair of regions in the environment, the min cut engine can then generate a minimum cut between the virtual node in the first region and the virtual node in the second region. This process is discussed in more detail below with respect to FIG. 2B.

The min cut engine 120 can use any appropriate algorithm to generate the minimum cuts of the graph 112. For example, the min cut engine 120 can execute Karger's algorithm or the Karger-Stein algorithm to generate the minimum cuts of the graph 112. These algorithms are discussed in more detail in “Experimental Study of Minimum Cut Algorithms,” Chekuri, Goldberg, Karger, Levine, and Stein, 1996.

In some implementations, for each minimum cut to be generated, the min cut engine 120 can first determine the maximum flow of the graph 112, and then determine the minimum cut from the determined maximum flow. For example, the min cut engine 120 can execute the Ford-Fulkerson algorithm to determine the maximum flow of the graph 112. Such algorithms are discussed in more detail in “An experimental comparison of min-cut/max-flow algorithms for energy minimization in vision,” DOI: 10.1109/TPAMI.2004.60.

As a particular example, after determining the maximum flow of the graph 112, the min cut engine 120 can determine the minimum cut of the graph 112 by removing the edges of the maximum flow from the graph 112 and then running a respective breadth-first search from both the source nodes and the destination nodes. Any edge that is in the original graph 112 but that is not reached by either of the breadth-first searches can be determined to be part of the minimum cut of the graph 112.

The choke point identification engine 130 is configured to process the min cut data 122 and to generate the data identifying the choke points 132 in the environment.

For each minimum cut represented in the min cut data 122, the choke point identification engine 130 can determine one or more candidate choke points identified by the minimum cut. In implementations in which the minimum cut identifies edges in the graph 112, the choke point identification engine 130 can determine, for each identified edge, a node that is incident to the identified edge to represent a candidate choke point. That is, the locations represented by the nodes incident to the edges can be candidate choke points. For example, the choke point identification engine 130 can select nodes incident to the identified edges such that a minimum number of nodes is selected; e.g., if multiple identified edges are incident to the same node, the choke point identification engine 130 can select the single node.

In implementations in which the minimum cut identifies nodes in the graph 112, the choke point can determine each identified node to represent a candidate choke point.

In some implementations, for each generated minimum cut, the choke point identification engine 130 can determine that each candidate choke point of the minimum cut is a choke point if the number of candidate choke points of the minimum cut satisfies a predetermined threshold. For example, the choke point identification engine 130 can determine each candidate choke point to be a choke point if the number of candidate choke points is below a threshold value, i.e., if there are fewer choke points from which vehicles can choose and therefore each choke point may be more congested with traffic. If the number of candidate choke points does not satisfy the threshold (e.g., if there are more candidate choke points than specified by the threshold), then the choke point identification engine 130 can determine that none of the candidate choke points are choke points. In some such implementations, the predetermined threshold is the same for each minimum cut, e.g., 1, 3, 5, or 10 candidate choke points. In some other implementations, the predetermined threshold for a particular minimum cut can depend on the regions corresponding to the particular minimum cut.

For example, for a particular minimum cut, the corresponding predetermined threshold can be determined according to a “default” minimum cut that corresponds to the same source region and destination region in the environment as the particular minimum cut, where the default minimum cut is generated under the assumption that the environment does not include any blockage points. That is, the choke point identification engine 130 can obtain a minimum cut for the source region and the destination region that has been generated using a different graph that represents the environment in the event that the environment does not include any blockage points. For example, the different graph can include a node for each location that is identified by a blockage point 104, signifying that those locations are navigable. The choke point identification engine 130 can then determine the predetermined threshold according to the number of nodes in the default minimum cut, e.g., by determining the predetermined threshold to be 10%, 30%, or 50% of the number of nodes in the default minimum cut.

The choke point identification system 100 can then provide data identifying the choke points 132 to one or more downstream systems for further processing, as described above.

In some implementations, after identifying choke points 132 between each pair of regions in the environment, the choke point identification system 100 can identify one or more regions of the environment that are isolated, i.e., relatively less connected to the other regions in the environment. For example, the choke point identification system 100 can generate data representing a matrix that has a number of rows and a number columns equal to the number of regions in the environment. The value of each element in the matrix is the number of choke points between the region corresponding to the row of the element and the region corresponding to the column of the element. As a particular example, the matrix can be the following:

| | Region 1 | Region 2 | Region 3 | Region 4 |
|---|---|---|---|---|
| Region 1 | — | 12 | 45 | 36 |
| Region 2 | 10 | — | 4 | 5 |
| Region 3 | 90 | 8 | — | 75 |
| Region 4 | 84 | 10 | 60 | — |

Not that the value of element (x,y) in the above example matrix is not necessarily the same as the value of element (y,x). That is, the matrix is not symmetric. This is because, as described above, the minimum cut from a first region to a second region can be different from the minimum cut from the second region to the first region.

The choke point identification system 100 can use the generated matrix to identify one or more regions in the environment that are isolated. Generally, a region is isolated if there are fewer choke points between the region and each other region in the environment (and therefore each choke point is more severe). For example, in the above matrix, Region 2 is less connected to the other regions in the environment than each of the other regions. The respective number of choke points between Region 2 and each other region ranges from 4 to 12, while the respective number of choke points between other pairs of regions ranges from 36 to 90.

As a particular example, the choke point identification system 100 can determine that a particular region is isolated if the average number of choke points between the particular region and each other region satisfies a threshold. For example, the threshold can be determined using the average number of choke points between each pair of regions in the environment, e.g., 5%, 10%, or 50% of the average number of choke points between each pair of regions in the environment.

In some implementations, the choke point identification system 100 can receive respective road data 102 and blockage points 104 corresponding to each of multiple environments, and generate data identifying choke points 132 in each of the multiple environments. For example, the choke point identification system 100 can process road data 102 representing each of multiple “service areas” of an autonomous vehicle or a fleet of autonomous vehicles.

FIG. 2A is an illustration of example graphs 210 and 220 representing an environment. Each node of the graphs 210 and 220 represents a respective location in the environment, and each edge between a respective pair of nodes represented a road between the corresponding pair of locations.

The first graph 210 represents the environment when there are not blockage points present in the environment. The first graph 210 includes one source node 212 and one destination node 214. As described above, a graph can generally include multiple different source nodes and/or multiple different destination nodes.

A system, e.g., the choke point identification system 100 depicted in FIG. 1, can determine a “default” minimum cut for the source node 212 and destination node 214 using the first graph 210, as described above. For example, the default minimum cut might include nodes 216, 218, and 219. Note that there are multiple possible minimum cuts for the first graph 210.

The system can receive data identifying the locations in the environment represented by the nodes 216 and 218 as blockage points. That is, the system can receive information that the locations represented by the nodes 216 and 218 are blocked for traffic.

In response to identifying the blockage points, the system can generate the second graph 220, which represents the same environment but does not include the nodes 216 and 218, because the locations represented by those nodes are no longer navigable.

The system can then determine a minimum cut of the second graph 220. The minimum cut includes only the node 219. This is the only possible minimum cut for the second graph 220.

The system can determine a set of candidate choke points from the minimum cut of the second graph 220—in this example, the only candidate choke point is the location represented by the node 219. The system can then determine whether the candidate choke points qualify as choke points, according to the default minimum cut. For example, the system can determine the proportion of the number nodes in the minimum cut of the second graph 220 compared to the number of nodes in the default minimum cut—in this example, ⅓=0.33. As a particular example, if the system compares the proportion against a predetermined threshold, e.g., 0.5, then the system would determine that the location represented by the node 219 is a choke point.

FIG. 2B is an illustration of an example graph 230. The graph 230 has the same nodes and edges as the graph 220 depicted in FIG. 2A.

A system, e.g., the choke point identification system 100 depicted in FIG. 1, can divide the environment represented by the graph 230 into two regions 232 and 234. Each node in the graph 230 is assigned to the region in which the location represented by the node is located.

In order to determine the minimum cut of the graph 230 from the first region 232 to the second region 234, instead of identifying one or more source nodes in the first region 232 and one or more destination nodes in the second region 234 as described above, the system can generate a first virtual node 236 and a respective virtual edge between the first virtual node 236 and each node in the first region 232, and a second virtual node 238 and a respective virtual edge between the second virtual node 238 and each node in the second region 234.

The system can then generate a minimum cut of the graph where the first virtual node 236 is designated as the source node and the second virtual node 238 is designated as the destination node. Doing so would again generate a minimum cut that includes only the node 219, as described above with respect to FIG. 2A.

Thus, generating a virtual node for each region in the environment and determining minimum cuts for each pair of virtual nodes is an alternative technique for identifying candidate choke points in the environment.

FIG. 2C is an illustration of graphs 250 and 260 representing an environment. FIG. 2C also illustrates example nodes 240 and 245 representing a particular location in an environment.

In some implementations, in order to determine the minimum cut of a graph, a system, e.g., the choke point identification system 100 depicted in FIG. 1, can expand each node in the graph into two different sub-nodes: a first sub-node that is incident to each incoming edge incident to the original node, and a second sub-node that is incident to each outgoing edge incident to the original node. A new “virtual” edge can connect the two sub-nodes of an expanded node. The weight of the new virtual edge, like all other edges in the graph, can be one—this limits the capacity of each node to be one.

For example, the graph can include the node 240, which is incident to three incoming edges and three outgoing edges. The system can expand the node 240 to generate the expanded node 245, which includes subnodes 242a-b connected by a virtual edge 244.

The system can then process the graph with the expanded nodes using a minimum cut algorithm as described above to identify one or more edges in the minimum cut of the graph. The graph is guaranteed to have a minimum cut that includes only edges that are virtual edges, i.e., edges that were added when expanding the nodes of the graph and that each connect the two sub-nodes of a respective original node.

The system can then determine candidate choke points from the generated minimum cut. In particular, the system can identify each original node for which the virtual edge of the corresponding expanded node is identified in the minimum cut, and determine the original node to represent a candidate choke point. In this example, if the virtual edge 244 is identified by the minimum cut, the system can determine the node 240 to represent a candidate choke point.

The graph 250 includes two rows of nodes 252 and 254. The nodes in each row of nodes 252 and 254 represent respective locations in a particular lane of a road in the environment. That is, the first row of nodes 252 represents a first lane of the road and the second row of nodes 254 represents a second lane of the road.

Edges between nodes in respective different rows 252 and 254 represent the option that a vehicle can change lanes between the two lanes of the road. For example, the first node in the first row 252 has a respective outgoing edge to the second, third, and fourth nodes in the second row 254, representing respective lane changes to the locations represented by the nodes in the second row 254.

In some implementations, before generating the minimum cut of the graph 250, a system, e.g., the choke point identification system 100 depicted in FIG. 1, can reduce the graph 250 to generate the reduced graph 260 by removing one or more edges that represent lane changes between respective lanes of a road in the environment. That is, the reduced graph 260 includes fewer edges between nodes in the first row 252 and the second row 254, and vice versa. In particular, for each particular node in the graph 250, the reduced graph 260 only includes the edge representing the shortest lane change possible between the particular node and a node representing the opposite lane of the road. For example, the first node in the first row 252 only has an outgoing edge to the second node in the second row 254. In other words, the system removes edges representing “redundant” lane changes, i.e., lane changes that are already represented by other edges in the graph.

Reducing the graph 250 by removing edges representing redundant lane changes can improve the execution of the minimum cut algorithm. For example, if the system processes the reduced graph 260 using a maximum flow algorithm, removing edges representing redundant lane changes can ensure that the maximum flow algorithm does not identify multiple redundant paths in the maximum flow of the graph, i.e., paths that include the same roads but slightly different lane changes. For example, a first redundant path might identify that the vehicle changes lanes from the location represented by the first node in the first row 252 to the location represented by the second node of the second row 252, while a second redundant path might identify that the vehicle changes lanes from the location represented by the first node in the first row 252 to the location represented by the third node of the second row 252.

Reducing the graph 250 by removing edges representing redundant lane changes can also ensure that the minimum cut of the graph is not artificially inflated. For example, the graph 250 has a minimum cut of four while the reduced graph 260 has a minimum cut of two, which better reflects the fact that the graphs 250 and 260 represent a single two-lane road. Thus, if the minimum cut of the graph 250 is a “default” minimum cut as described above, reducing the graph 250 can ensure that the threshold is consistent when determining a threshold for identifying choke points using the default minimum cut.

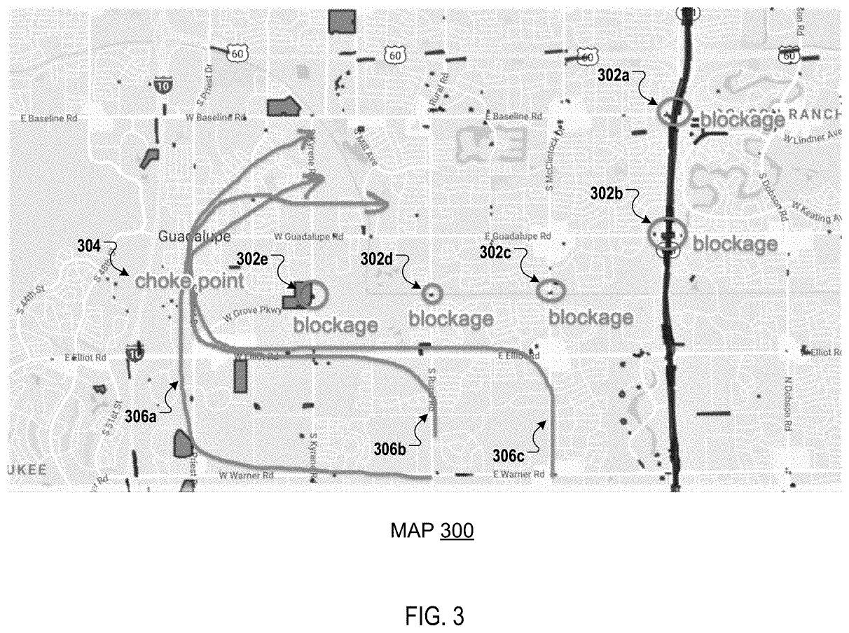

FIG. 3 is an illustration of an example map 300 that includes blockage points 302a-e and a choke point 304. The map 300 is an example of road data representing the roads in an environment.

Each blockage point 302a-e is a location on the road that is currently blocked from traffic. Therefore, if a vehicle is traveling from any location in the southern region of the environment to any location in the northern region of the map, the vehicle must navigate through the choke point 304. For example, each of the illustrated routes 306a-c navigate through the choke point 304, potentially causing significant traffic congestion at the choke point 304.

A choke point identification system, e.g., the choke point identification system 100 depicted in FIG. 1, can generate data identifying the choke point 304 and provide the data to one or more downstream systems. For example, the choke point identification system can provide the data to an on-board navigational system of a vehicle in the environment that is configured to generate routes for the vehicle. The navigational system can use the data to attempt to avoid the choke point 304 if possible. For example, if the vehicle is traveling from the southwestern region of the environment to the north-eastern region, then the navigational system can generate a route for the vehicle that first navigates towards the east and then towards the north, avoiding the choke points 302a-e.

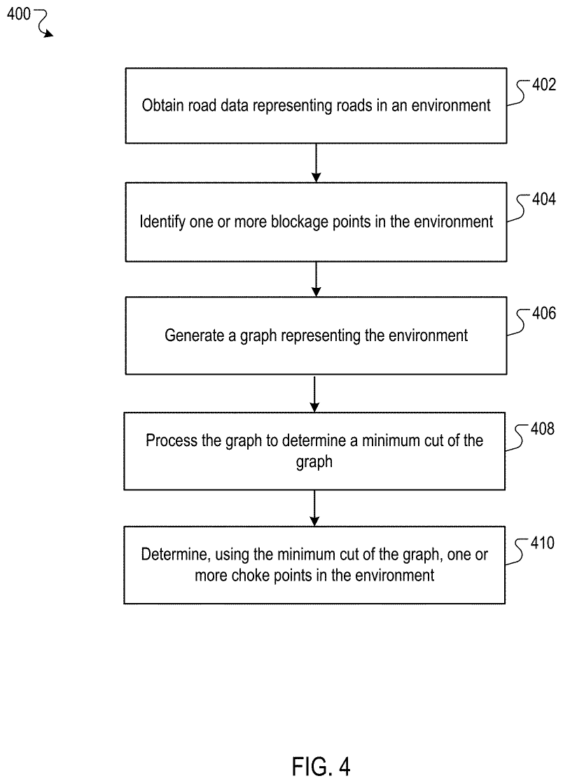

FIG. 4 is a flow diagram of an example process 400 for identifying choke points in an environment. For convenience, the process 400 will be described as being performed by a system of one or more computers located in one or more locations. For example, a choke point identification system, e.g., the choke point identification system 100 depicted in FIG. 1, appropriately programmed in accordance with this specification, can perform the process 400.

The system obtains road data representing multiple roads in an environment (step 402).

The system identifies one or more blockage points in the environment (step 404). Each blockage point is a location on a respective road in the environment that is identified by the obtained road data as navigable but through which vehicles are not currently able to navigate.

The system generates a graph representing the environment (step 406). The graph includes multiple nodes and edges, where each node of the graph represents a respective location in the environment and each edge between a first node and a second node represents a road that connects the location in the environment represented by the first node and the location in the environment represented by the second node. Blockage points are not represented by nodes in the graph.

The system processes the graph to determine a minimum cut of the graph (step 408).

For example, the system can select selecting a source set of locations and a destination set of locations in the environment, wherein each set of locations includes one or more locations in the environment. The system can then determine a minimum cut of the graph for the source set of locations and the destination set of locations.

The system determines, using the minimum cut of the graph, one or more choke points in the environment (step 410). For example, the system can determine whether a number of nodes identified by the minimum cut of the graph exceeds a predetermined threshold. The predetermined threshold can be determined according to a number of nodes identified by a second minimum cut corresponding to the environment when no blockage points are present, e.g., a predetermined proportion of the number of nodes identified by the second minimum cut.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a method comprising:

obtaining road data representing a plurality of roads in an environment;

identifying one or more blockage points in the environment, wherein each blockage point is a location on a respective road in the environment that is identified by the obtained road data as navigable but through which vehicles are not able to navigate;

generating, using the road data and the identified blockage points, a graph representing the environment, wherein:
the graph comprises a plurality of nodes and edges,
each node of the graph represents a respective location in the environment,
each edge between a first node and a second node represents a road that connects the location in the environment represented by the first node and the location in the environment represented by the second node, and
blockage points are not represented by nodes in the graph;

processing the graph to determine a minimum cut of the graph; and

determining, using the minimum cut of the graph, one or more choke points in the environment.

Embodiment 2 is the method of embodiment 1, wherein determining a minimum cut of the graph comprises:

selecting a source set of locations and a destination set of locations in the environment, wherein each set of locations includes one or more locations in the environment; and

determining a minimum cut of the graph for the source set of locations and the destination set of locations.

Embodiment 3 is the method of embodiment 2, wherein determining one or more choke points comprises determining whether a number of nodes identified by the minimum cut of the graph exceeds a predetermined threshold.

Embodiment 4 is the method of embodiment 3, wherein the predetermined threshold is determined according to a number of nodes identified by a second minimum cut corresponding to the environment when no blockage points are present.

Embodiment 5 is the method of any one of embodiments 1-4, wherein determining a minimum cut of the graph comprises:

determining a plurality of regions of the environment; and

for each first region of the environment and for each second region that is different from the first region of the environment:
selecting a source set of locations that includes one or more locations in the first region;
selecting a destination set of locations that includes one or more locations in the second region; and
determining a minimum cut of the graph for the source set of locations and the destination set of locations.

Embodiment 6 is the method of embodiment 5, wherein determining one or more choke points comprises, for each first region and each second region, determining whether a number of nodes identified by the minimum cut of the graph corresponding to the first and second region exceeds a predetermined threshold.

Embodiment 7 is the method of embodiment 6, wherein the predetermined threshold is determined according to a number of nodes identified by a second minimum cut for the first and second region corresponding to the environment when no blockage points are present.

Embodiment 8 is a system comprising one or more computers and one or more storage devices storing instructions that when executed by the one or more computers cause the one more computers to perform operations comprising the method of any one of embodiments 1-7.

Embodiment 9 is one or more non-transitory computer storage media storing instructions that when executed by one or more computers cause the one more computers to perform operations comprising the method of any one of embodiments 1-7.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method comprising:
obtaining road data representing a plurality of roads in an environment;
identifying one or more blockage points in the environment, wherein each blockage point is a location on a respective road in the environment that is identified by the obtained road data as navigable but through which vehicles are not able to navigate;
generating, using the road data and the identified blockage points, a graph representing the environment, wherein:
the graph comprises a plurality of nodes and edges,
each node of the graph represents a respective location in the environment,
each edge between a first node and a second node represents a road that connects the location in the environment represented by the first node and the location in the environment represented by the second node, and
blockage points are not represented by nodes in the graph;
processing the graph to determine a minimum cut of the graph; and
determining, using the minimum cut of the graph, one or more choke points in the environment.

2. The method of claim 1, wherein determining a minimum cut of the graph comprises:
selecting a source set of locations and a destination set of locations in the environment, wherein each set of locations includes one or more locations in the environment; and
determining a minimum cut of the graph for the source set of locations and the destination set of locations.

3. The method of claim 2, wherein determining one or more choke points comprises determining whether a number of nodes identified by the minimum cut of the graph exceeds a predetermined threshold.

4. The method of claim 3, wherein the predetermined threshold is determined according to a number of nodes identified by a second minimum cut corresponding to the environment when no blockage points are present.

5. The method of claim 1, wherein determining a minimum cut of the graph comprises:
determining a plurality of regions of the environment; and
for each first region of the environment and for each second region that is different from the first region of the environment:
selecting a source set of locations that includes one or more locations in the first region;
selecting a destination set of locations that includes one or more locations in the second region; and
determining a minimum cut of the graph for the source set of locations and the destination set of locations.

6. The method of claim 5, wherein determining one or more choke points comprises, for each first region and each second region, determining whether a number of nodes identified by the minimum cut of the graph corresponding to the first and second region exceeds a predetermined threshold.

7. The method of claim 6, wherein the predetermined threshold is determined according to a number of nodes identified by a second minimum cut for the first and second region corresponding to the environment when no blockage points are present.

8. A system comprising one or more computers and one or more storage devices storing instructions that when executed by the one or more computers cause the one more computers to perform operations comprising:
obtaining road data representing a plurality of roads in an environment;
identifying one or more blockage points in the environment, wherein each blockage point is a location on a respective road in the environment that is identified by the obtained road data as navigable but through which vehicles are not able to navigate;
generating, using the road data and the identified blockage points, a graph representing the environment, wherein:
the graph comprises a plurality of nodes and edges,
each node of the graph represents a respective location in the environment,
each edge between a first node and a second node represents a road that connects the location in the environment represented by the first node and the location in the environment represented by the second node, and
blockage points are not represented by nodes in the graph;
processing the graph to determine a minimum cut of the graph; and
determining, using the minimum cut of the graph, one or more choke points in the environment.

9. The system of claim 8, wherein determining a minimum cut of the graph comprises:
selecting a source set of locations and a destination set of locations in the environment, wherein each set of locations includes one or more locations in the environment; and
determining a minimum cut of the graph for the source set of locations and the destination set of locations.

10. The system of claim 9, wherein determining one or more choke points comprises determining whether a number of nodes identified by the minimum cut of the graph exceeds a predetermined threshold.

11. The system of claim 10, wherein the predetermined threshold is determined according to a number of nodes identified by a second minimum cut corresponding to the environment when no blockage points are present.

12. The system of claim 8, wherein determining a minimum cut of the graph comprises:
determining a plurality of regions of the environment; and
for each first region of the environment and for each second region that is different from the first region of the environment:
selecting a source set of locations that includes one or more locations in the first region;
selecting a destination set of locations that includes one or more locations in the second region; and
determining a minimum cut of the graph for the source set of locations and the destination set of locations.

13. The system of claim 12, wherein determining one or more choke points comprises, for each first region and each second region, determining whether a number of nodes identified by the minimum cut of the graph corresponding to the first and second region exceeds a predetermined threshold.

14. The system of claim 13, wherein the predetermined threshold is determined according to a number of nodes identified by a second minimum cut for the first and second region corresponding to the environment when no blockage points are present.

15. One or more non-transitory computer storage media storing instructions that when executed by one or more computers cause the one more computers to perform operations comprising:
obtaining road data representing a plurality of roads in an environment;
identifying one or more blockage points in the environment, wherein each blockage point is a location on a respective road in the environment that is identified by the obtained road data as navigable but through which vehicles are not able to navigate;
generating, using the road data and the identified blockage points, a graph representing the environment, wherein:
the graph comprises a plurality of nodes and edges,
each node of the graph represents a respective location in the environment,
each edge between a first node and a second node represents a road that connects the location in the environment represented by the first node and the location in the environment represented by the second node, and
blockage points are not represented by nodes in the graph;
processing the graph to determine a minimum cut of the graph; and
determining, using the minimum cut of the graph, one or more choke points in the environment.

16. The non-transitory computer storage media of claim 15, wherein determining a minimum cut of the graph comprises:
selecting a source set of locations and a destination set of locations in the environment, wherein each set of locations includes one or more locations in the environment; and
determining a minimum cut of the graph for the source set of locations and the destination set of locations.

17. The non-transitory computer storage media of claim 16, wherein determining one or more choke points comprises determining whether a number of nodes identified by the minimum cut of the graph exceeds a predetermined threshold.

18. The non-transitory computer storage media of claim 17, wherein the predetermined threshold is determined according to a number of nodes identified by a second minimum cut corresponding to the environment when no blockage points are present.

19. The non-transitory computer storage media of claim 15, wherein determining a minimum cut of the graph comprises:
determining a plurality of regions of the environment; and
for each first region of the environment and for each second region that is different from the first region of the environment:
selecting a source set of locations that includes one or more locations in the first region;
selecting a destination set of locations that includes one or more locations in the second region; and
determining a minimum cut of the graph for the source set of locations and the destination set of locations.

20. The non-transitory computer storage media of claim 19, wherein determining one or more choke points comprises, for each first region and each second region, determining whether a number of nodes identified by the minimum cut of the graph corresponding to the first and second region exceeds a predetermined threshold.
